(19) United States
(12) Patent Application Publication
(10) Pub. No.: US 2004/0193710 A1
(43) Pub. Date: Sep. 30, 2004

(54) Service providing system with multiple state management servers

(76) Inventor: Kazumasa Ushiki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/787,693

(22) Filed: Feb. 25, 2004

(30) Foreign Application Priority Data
Mar. 28, 2003 (JP) 2003-092864

(51) Int. Cl. G06F 15/173

(52) U.S. Cl. 709/224

(57) ABSTRACT

A service providing system is disclosed including multiple state management servers each provided to a segment of a service area. When a user terminal stays in the segment to which the state management server is provided, the state management server manages state information of the owner of the user terminal. The system also includes an application server that executes an application program for providing the user terminal with a service. The state management server manages the state information of the owner of the user terminal staying in the segment to which the state management server is provided. The state management server can dedicate itself to manage only the state information of owners of user terminals staying in the segment for which the state management server is responsible. Even if the service area is large and a large number of users stay in the service area, the load on each state management server can be reduced.

### BACKGROUND OF THE INVENTION

1. Field of the Invention

The present invention generally relates to a service providing system, and more particularly, to a service providing system that provides a user's terminal staying in a service area with services depending on the state of the user.

2. Description of the Related Art

Various services are being provided to users who have information terminals connected to communication networks such as the Internet and mobile communication networks.

For example, a method of providing services is proposed in which a railway pass holder who has registered his/her e-mail address can receive an e-mail message containing useful information. When the railway pass holder arrives at a railway station, for example, the e-mail message is transmitted to his/her mobile terminal (see URL: http://www.goopas.jp/noflash/virtual.html, searched on Mar. 7, 2003, for example).

Japanese Patent Laid-Open Application No. 06-133359 discloses a method of continuously providing a subscriber with services, the subscriber moving from the network of a service provider with whom the subscriber has a subscription contract, to the network of another service provider with whom the subscriber has no subscription contract. A home location center register of the service provider transfers the information about the subscriber to a visitor location register of the other service provider.

In the case of the method of providing services in which the railway pass holder can receive an e-mail message, only the railway pass holders can enjoy the service in area along the railway. As a result of this limitation, only a small system is required for providing the services. The system may include a single server (state management server) that manages the state of the railway pass holders (users).

As the area in which services are provided is expanded, users to whom the services are provided increase. If only one state management server is provided to the system, the state management server may be overloaded. If a service fine tuned to the state of each individual user needs to be provided, the state management server needs to manage a lot of information even for one user, which increases the load on the state management server. Additionally, since the distance between the state management server and the user increases, the load on the communication network also increases.

In the case of the above method of continuously providing a subscriber (user) with services disclosed in Japanese Patent Laid-Open Application No. 06-133359, even if the area in which services are provided is expanded, the server and the communication network are not overloaded. However, the system cannot manage multiple items of information about the state of each user. As a result, the service cannot be fine tuned to the state of each individual user.

### SUMMARY OF THE INVENTION

Accordingly, it is a general object of the present invention to provide a novel and useful system in which one or more of the problems described above are eliminated.

Another and more specific object of the present invention is to provide a system for providing a user terminal with appropriate services tuned to the state of the owner of the user terminal even in a large scale area of service.

To achieve at least one of the above objects, a service providing system according to the present invention includes: a plurality of state management servers each provided to a segment of a service area, wherein, when a user terminal stays in the segment to which the state management server is provided, the state management server manages state information of the owner of the user terminal; and an application server that executes an application program for providing the user terminal with a service.

The service area of the service providing system is divided into a plurality of segments. One of the state management servers is provided to each segment of the service area, and manages the state information of the owner of the user terminal staying in the segment to which the state management server is provided. The state management server can dedicate itself to manage only the state information of the owners of user terminals staying in the segment for which the state management server is responsible, and does not need to manage the state information of the owners of user terminals staying in the other segments of the service area. According to the above arrangements, even if the service area is large, a large number of user terminals stay in the service area, and even if the state information of the owner of a user terminal includes many items, the load on each state management server can be reduced. Additionally, since the state management servers are distributed, the distance between the state management server and the user terminals can be shortened, which reduces the load on the communication network.

According to another aspect of the present invention, the service providing system described above is characterized in that, when the user terminal moves from a first segment of the service area to a second segment of the service area, a first one of said state management servers provided to the first segment of the service area transmits the state information of the owner of the user terminal to a second one of said state management servers provided to the second segment of the service area.

When the user terminal moves from the first segment of the service area to the second segment of the service area, the state information of the owner of the user terminal is transmitted from the first one of said state management servers provided to the first segment of the service area to a second one of said state management servers provided to the second segment of the service area. According to the above arrangements, even if the user terminal moves from one segment to another, the service providing system can keep providing the user terminal with services suitable for the state of the owner of the user terminal.

Other objects, features, and advantages of the present invention will become more apparent from the following detailed description when read in conjunction with the accompanying drawings.

### BRIEF DESCRIPTION OF THE DRAWINGS

FIG. 1 is a schematic diagram showing the structure of a service providing system according to an embodiment of the present invention;

FIG. 2 is a schematic diagram showing the operation of the service providing system according to the embodiment in which a user terminal moves from one area to another;

FIG. 3 is a flowchart showing the operation of a current state management server according to an embodiment;

FIG. 4 is a flowchart showing the operation of a previous state management server according to an embodiment;

FIG. 5 is a flowchart showing the partial activation of triggers of the current state management server according to an embodiment;

FIG. 6 is a flowchart showing the operation of the previous state management server in which partially activated triggers are processed;

FIG. 7 is a schematic diagram showing the structure of the service providing system in which an intermediary server is provided;

FIG. 8 is a flowchart showing the operation of the current state management server shown in FIG. 7 according to an embodiment;

FIG. 9 is a flowchart showing the operation of the intermediary server shown in FIG. 7 according to an embodiment;

FIG. 10 is a flowchart showing the operation of the previous state management server shown in FIG. 7 according to an embodiment;

FIG. 11 is a flowchart showing the partial activation of the intermediary server shown in FIG. 7;

FIG. 12 is a schematic diagram showing the operation of the service providing system in which user state is updated;

FIG. 13 is a flowchart showing the operation of the current state management server shown in FIG. 12;

FIG. 14 is a flowchart showing the operation of the application server that has received a trigger notice as shown in FIG. 12;

FIG. 15 is a flowchart showing the operation of the application server that receives a user notice as shown in FIG. 12;

FIG. 16 is a schematic diagram showing the operation of the service providing system in which a new trigger is set;

FIG. 17 is a flowchart showing the operation of the application server shown in FIG. 16;

FIG. 18 is a flowchart showing the operation of a location server shown in FIG. 16;

FIG. 19 is a sequence chart showing a first embodiment of user state management;

FIG. 20 is a table of exemplary trigger information shown in FIG. 19;

FIG. 21 is another table of exemplary trigger information shown in FIG. 19;

FIG. 22 is a sequence chart showing a second embodiment of user state management;

FIG. 23 is a sequence chart showing a third embodiment of user state management;

FIG. 24 is a table of an exemplary trigger for state notice used in the operation shown in FIG. 23;

FIG. 25 is another table of exemplary trigger information used in the operation shown in FIG. 23;

FIG. 26 is a table of exemplary state information common for users used in the operation shown in FIG. 23;

FIG. 27 is a table of exemplary user analysis information used in the operation shown in FIG. 23; and

FIG. 28 is a table of exemplary information indicating whether user analysis is allowed to be used in the operation shown in FIG. 23.

### DETAILED DESCRIPTION OF THE PREFERRED EMBODIMENTS

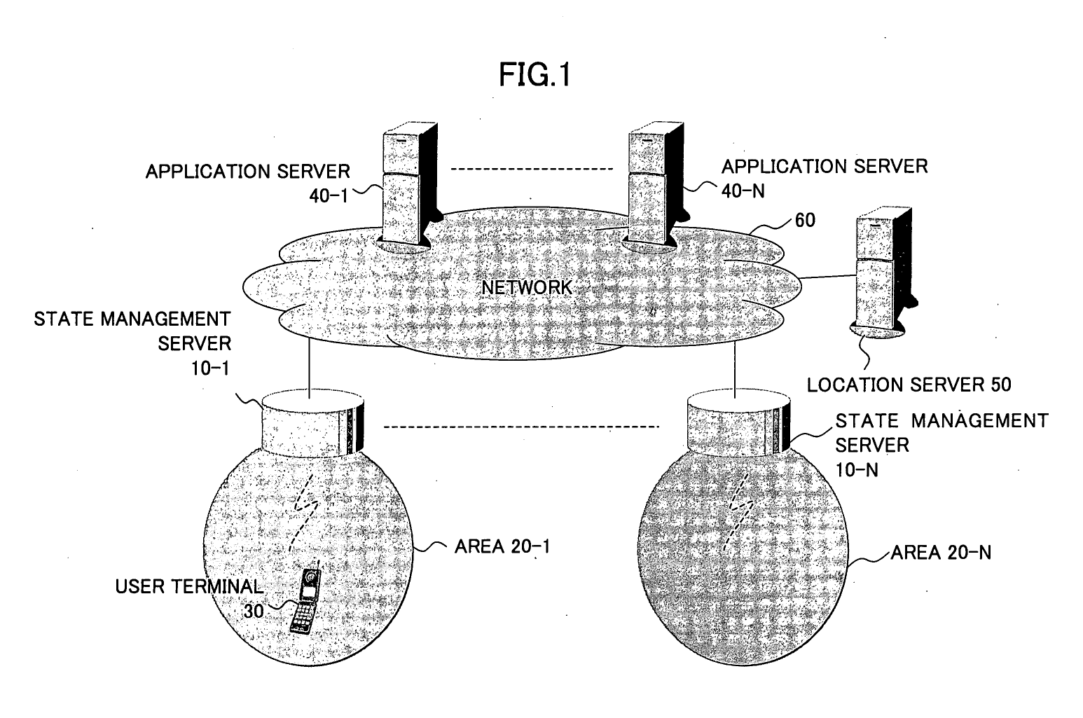

FIG. 1 is a schematic diagram showing the structure of a service providing system according to an embodiment of the present invention. The service providing system shown in FIG. 1 includes the following: state management servers 10-1 through 10-N (hereinafter may be referred to as state management servers 10), user terminal 30, application servers 40-1 through 40-M (hereinafter may be referred to as application servers 40), and a network 60.

The service providing system provides service to multiple areas 20-1 through 20-N (hereinafter may be referred to as areas 20). Specifically, the service providing system provides the user terminal 30 of each user with service tuned to the state of the user.

A state management server 10 is provided in the neighborhood of each area 20. The state management server 10 manages state information of a user having a user terminal 30, the user belonging to an area managed by the state management server 10. A state management server 10-1, for example, manages state information of the user having a user terminal 30, the user belonging to an area 20-1 managed by the state management server 10-1. The state information of a user includes information about the user such as a position, likes, mental condition, and belongings.

The application server 40 executes an application program for providing services to the user terminal 30. The location server 50 manages the information of position of the user terminal 30. Instead of the location server 50, another server such as an authentication server that authenticates users may manage the information of position of the user terminal 30. The state management server 10, the application server 40, and the location server 50 are connected to the network 60.

When the user terminal 30 moves from a first area 20 to a second area 20, the state information of the user is transferred from the state management server of the first area 20 to the state management server of the second area 20.

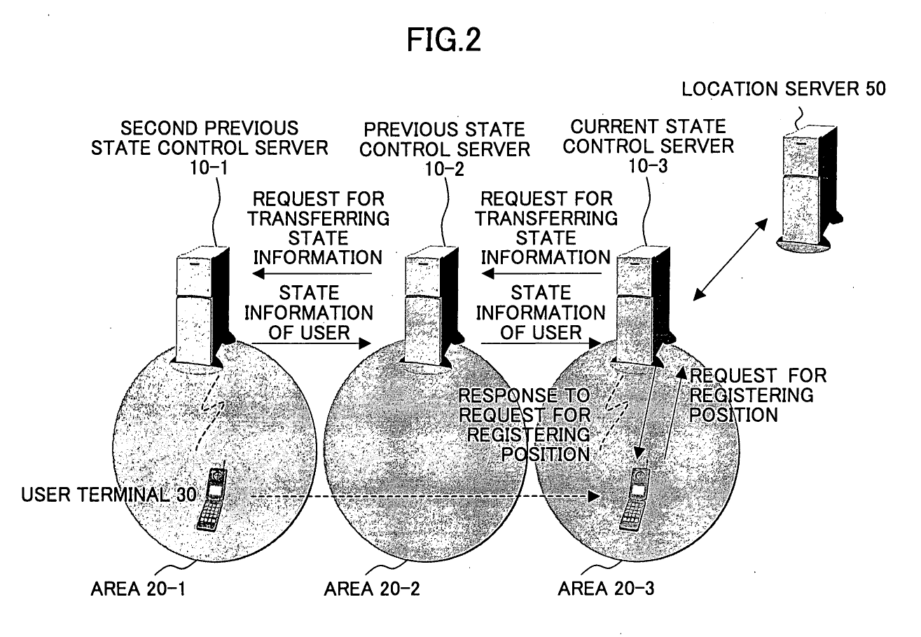

FIG. 2 is a schematic diagram showing processing tasks of the service providing system performed when the user terminal 30 moves from the area 20-1 to the other area 20-2, and further moves from the area 20-2 to the other area 20-3.

When the user terminal 30 moves from an area 20 to another area 20, the user terminal 30 transmits a request for registering its position to the state management server 10 of the other area 20. The location server 50 registers the position of the user terminal 30 in response to receipt of the request, and transmits a response to the request to the user terminal 30 via the state management server 10 of the area 20 into which the user terminal 30 has moved. The location server 50 stores address information of the state management server 10 of the area 20 where the user terminal 30 exits. The location server 50 includes the address information in the response to the request for registering the position.

When the user terminal 30 moves from the area 20-1 to the area 20-2, a state management server 10-2 (previous state management server) of the area 20-2 that the user terminal 30 enters transmits a request for transferring state information to a state management server (second previous state management server) 10-1 of the area 20-1 that the user terminal 30 exits. In response to the request, the second previous state management server 10-1 transmits a response to the request for transferring the state information to the previous state management server 10-2, the request including the state information of the user terminal 30 and information (hereinafter referred to as trigger information) about a condition set (hereinafter referred to as triggers) related to the services to be provided to the user terminal 30.

When the user terminal 30 moves from the area 20-2 to the area 20-3, a state management server (current state management server) 10-3 transmits a request for transferring state information of the user terminal 30 to the previous state management server 10-2 of the area 20-2 that the user terminal 30 exits. In response to the request, the previous state management server 10-2 transmits a response to the request to the current state management server 10-3, the response including the state information of the user terminal 30 and the trigger information.

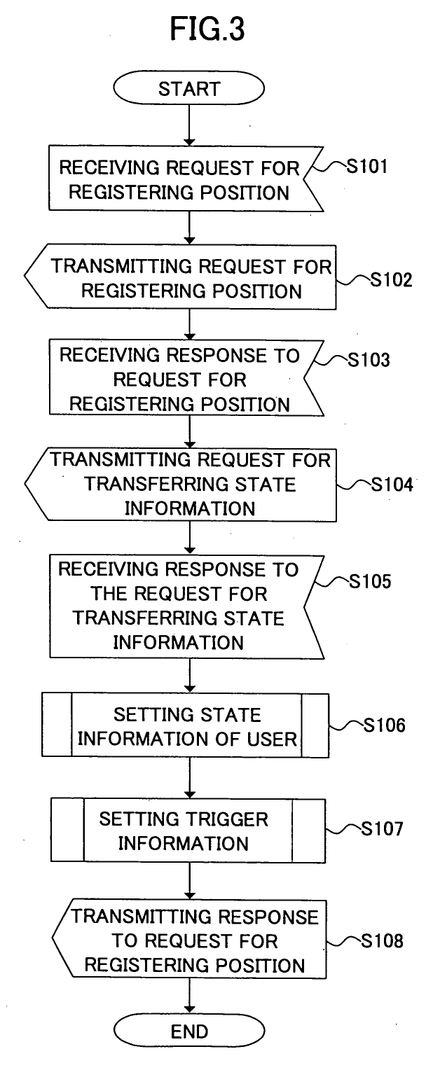

FIG. 3 is a-flowchart showing the operation of the current state management server 10-3 shown in FIG. 2. When the user terminal 30 moves into the area 20-3 of the current state management server 10-3, the user terminal 30 transmits a request for registering its position to the current state management server 10-3 (step S101). The current state management server 10-3 transmits the received request for registering the position of the user terminal 30 to the location server 50 (step S102), and receives a response to the request from the location server 50 (step S103).

If the location server 50 successfully registers the position of the user terminal 30, the current state management server 10-3 transmits a request for transferring the state information and trigger information of the user terminal 30 to the previous state management server 10-2 (step S104). The current state management server 10-3 is informed of the address of the previous state management server 10-2 by the location server 50 via the response to the request for registering the position of the user terminal 30 or by the user terminal 30 via the request for registering its position. According to these arrangements, the current state management server 10-3 can access the previous state management server 10-2.

The current state management server 10-3 receives a response to the request for transferring state information from the previous state management server 10-2 (step S105). The response includes the state information of the user terminal 30 and the trigger information of the user terminal 30. The current state management server 10-3 sets up the state information contained in the response from the previous state management server 10-3 as the state information corresponding to the user terminal 30 (step S106).

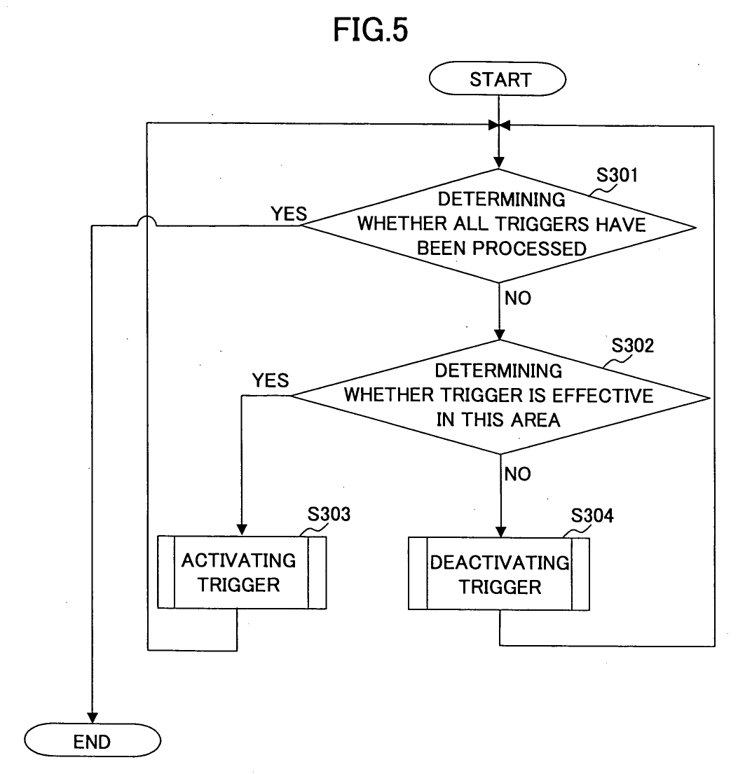

Subsequent to step S106, the current state management server 10-3 sets up the trigger information contained in the response from the previous state management server 10-2 for analyzing (step S107). If the trigger information needs to be partially activated, the current state management server 10-3 follows the operation shown in FIG. 5 (described below). The current state management server 10-3 transmits a response to the request for registering the position to the user terminal 30 (step S108).

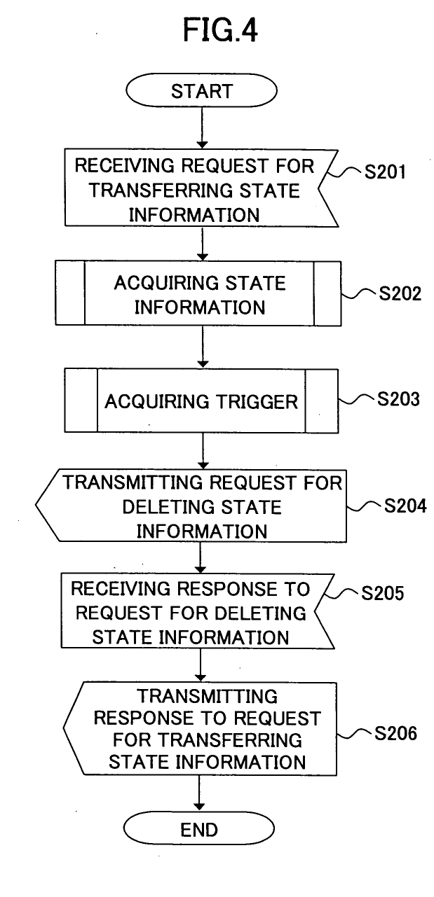

FIG. 4 is a flowchart showing the operation of the previous state management server 10-2 shown in FIG. 2. The previous state management server 10-2 receives the request for transferring the state information from the current state management server 10-3 (step S201).

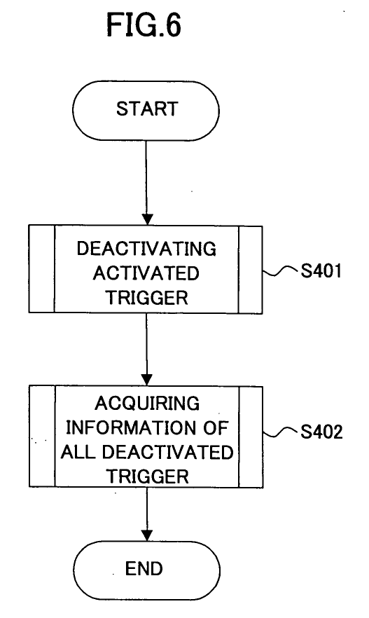

The previous state management server 10-2 retrieves the state information and the trigger information corresponding to the user terminal 30 stored therein (steps S202, S203). If the trigger information needs to be partially activated, the previous state management server 10-2 follows the operation shown in FIG. 6 (described below). The previous state management server 10-2 transmits, to the second previous state management server 10-2, a request for deleting state information stored therein (step S204). In response to receipt of the request, the second previous state management server 10-1 deletes the state information and the trigger information corresponding to the designated user terminal 30, and transmits a response to the request to the previous state management server 10-2.

The previous state management server 10-2 receives the response from the second previous state management server 10-1 (step S205). The previous state management server 10-2 transmits a response to the request for transferring state information containing the state information and the trigger information corresponding to the user terminal 30 to the current state management server 10-3 (step S206).

FIG. 5 is a flowchart showing a partial activation process performed by the current state management server 10-3. The partial activation process is a process in which the state management server 10 activates only items of the trigger information that are effective in the area 20 for which the state management server 10 is responsible.

The current state management server 10-3 determines whether it has processed all items of the trigger information of the user terminal 30 included in the response to the request for transferring the state information (step S301). If all items of the trigger information have been processed, the current state management server 10-3 exits the process. If all items of the trigger information have not been processed yet, the current state management server 10-3 determines whether the item of the trigger information is effective in the area 20-3 for which the current state management server 10-3 is responsible (step S302).

If an item of the trigger information is effective in the area 20-3, the current state management server 10-3 activates the item of the trigger information for processing (step S303). On the other hand, if the item of the trigger information is not effective in the area 20-3, the current state management server 10-3 stores (deactivates) the trigger information without processing it (step S304). Subsequent to steps S303 and S304, the current state management server 10-3 repeats steps starting with S301.

FIG. 6 is a flowchart of the operation of the previous state management server 10-2 in which the partially activated trigger is processed. After the user terminal 30 moves out of the area 20-2, the previous state management server 10-2 deactivates and stores activated items of the trigger information corresponding to the user terminal 30 (step S401). Then, the previous state management server 10-2 acquires all the stored trigger information including the trigger information stored in step S401 (step S402). The previous state management server 10-2 can include the acquired items of the trigger information in the response to the request for transferring the state information, and transmit the acquired items of the trigger information to the current state management server 10-3. The operation shown in FIG. 6 may be performed when or after the previous state management server 10-2 transmits the state information of the user to the current state management server 10-3.

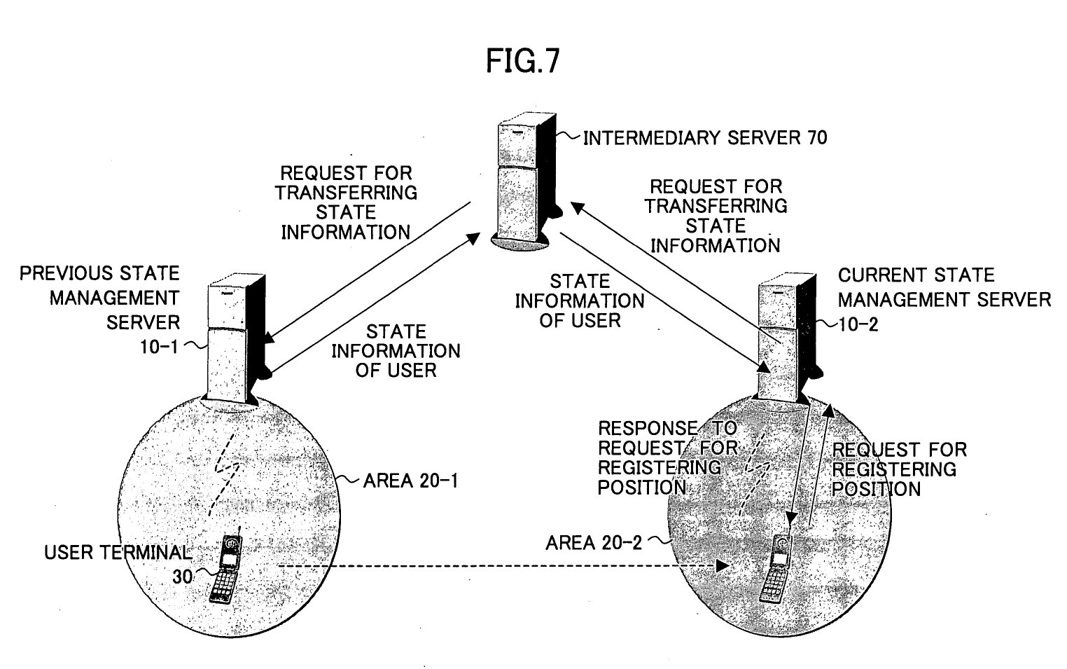

FIG. 7 is a schematic diagram showing a service providing system including an intermediary server. The intermediary server 70 operates as the location server that manages the position information of the user terminal 30. The user terminal 30 moves from the area 20-1 to the area 20-2.

When moving from the area 20-1 to the area 20-2, the user terminal 30 transmits a request for registering its position information to the intermediary server 70 via the current state management server 10-2 responsible for the area 20-2. In response to the request, the intermediary server 70 registers the position information of the user terminal 30. Additionally, the intermediary server 70 acquires the state information and the trigger information corresponding to the user terminal 30 from the previous state management server 10-1 responsible for the area 20-1, and transmits a response to the request for registering the position information to the current state management server 10-2, the response including the state information and the trigger information of the user having the user terminal 30.

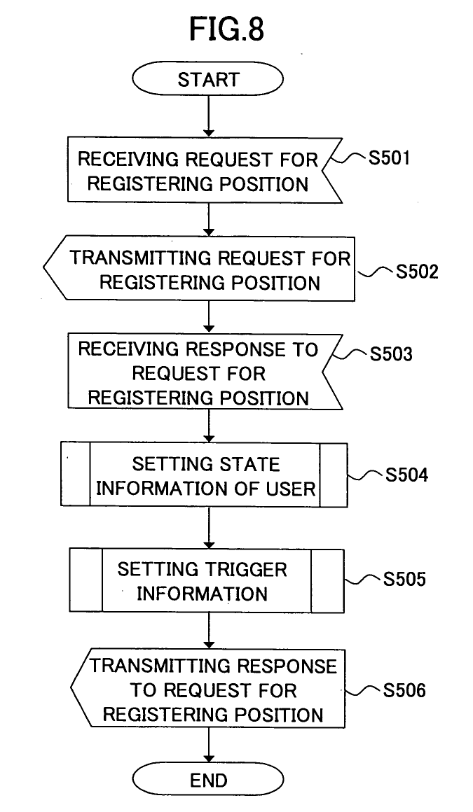

FIG. 8 is a flowchart showing the operation of the current state management server 10-2 shown in FIG. 7. When the user terminal 30 moves to the area 20-2, the current state management server 10-2 receives a request for registering position information from the user terminal 30 (step S501). The current state management server 10-2 transmits the received request for registering the state information to the intermediary server 70 (step S502). Then, the current state management server 10-2 receives a response to the request from the intermediary server 70 (step S503).

When the position information of the user terminal 30 is successfully registered by the intermediary server 70, the current state management server 10-2 sets up the state information of the user included in the received response as state information of a user corresponding to the user terminal 30 staying in the area 20-2 to which the current state management server 10-2 is responsible (step S504).

The current state management server 10-2 sets up the trigger information included in the response for analyzing the trigger information (step S505). The current state management server 10-2 transmits the response to the request for registering the position information to the user terminal 30 (step S506).

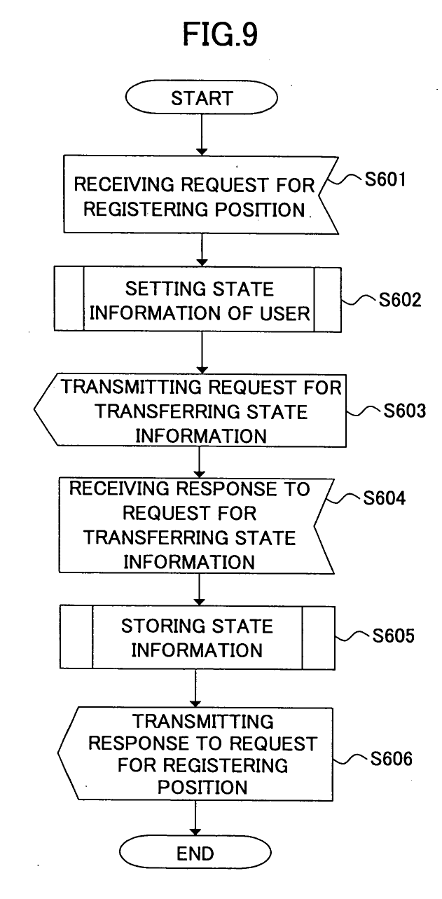

FIG. 9 is a flowchart showing the operation of the intermediary server 70 shown in FIG. 7. The intermediary server 70 receives a request for registering the position information from the current state management server 10-2 (step S601).

In response to receipt of the request, the intermediary server 70 processes the request from the user terminal 30 (step S602). The intermediary server 70 transmits, to the previous state management server 10-1, a request for transferring state information and trigger information of the user corresponding to the user terminal 30 (step S603). The intermediary server 70 has address information of the previous state management server 10-1 responsible for the area 20-1 from which the user terminal 30 has moved for controlling the move of the user terminal 30. As a result, the intermediary server 70 can access the previous state management server 10-1 based on the address information.

The intermediary server 70 receives a response to the request for transferring state information from the previous state management server 10-2 (step S604). The response includes the state information and the trigger information of the user corresponding to the user terminal 30. The intermediary server 70 stores the state information and the trigger information included in the response (step S605), and transmits the response to the request for registering the position information including the state information and the trigger information of the user to the current state management server 10-3 (step S606).

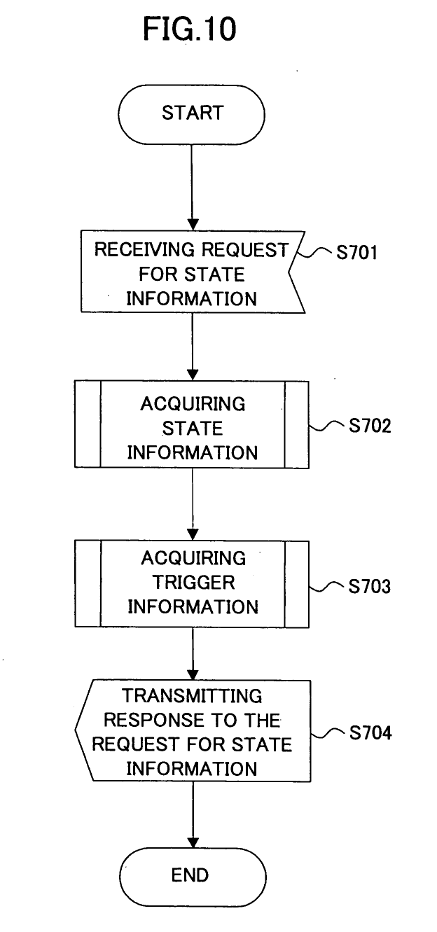

FIG. 10 is a flowchart showing the operation of the previous state management server 10-1 shown in FIG. 7. The previous state management server 10-1 receives the request for transferring state information from the intermediary server 70 (step S701).

The previous state management server 10-1 acquires the user state information and the trigger information corresponding to the user terminal 30 (steps S702, S703). The previous state management server 10-1 transmits, to the intermediary server 70, a response to the request including the user state information and the trigger information (step S704).

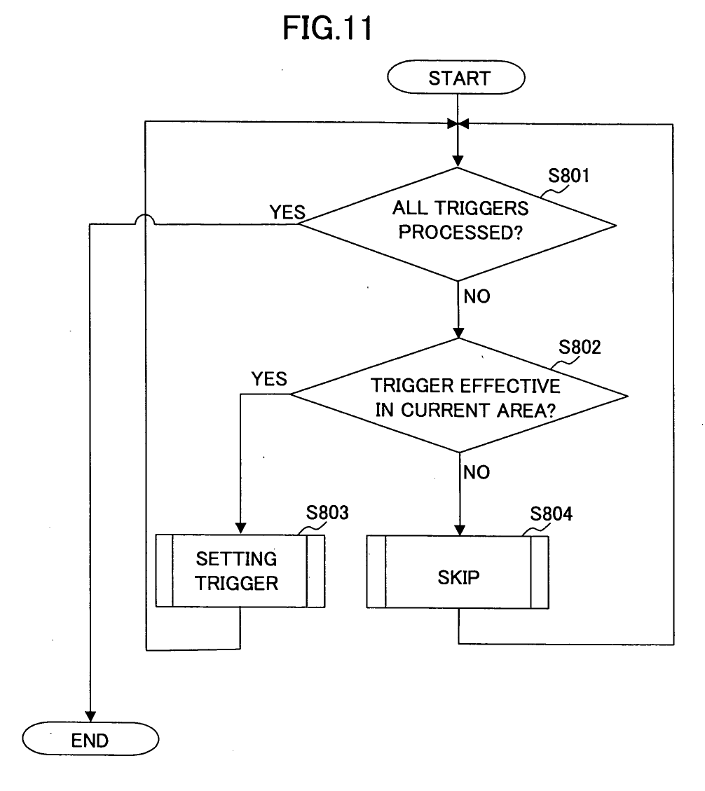

FIG. 11 is a flowchart showing the operation of the intermediary server 70 shown in FIG. 7 in which the trigger information is partially activated. The intermediary server 70 determines whether all trigger information corresponding to the user terminal 30 has been processed (step S801). If the intermediary server 70 determines that it has processed all items of the trigger information, the intermediary server 70 terminates the process. If the intermediary server 70 determines that it has not processed all items of the trigger information, the intermediary server 70 determines whether the item of the trigger information is effective in the area 20-2 of the current state management server 10-2 (step S802).

If the intermediary server 70 determines that the item of the trigger information that has not been activated yet is effective in the area 20-2 of the current state management server 10-2, the intermediary server 70 activates the item of the trigger information for analysis (sets activated) (step S803). If the item of the trigger information is not effective in the area 20-2, the intermediary server 70 leaves the item of the trigger information inactivated (skips) (step S804). After steps S803 and S804, steps S801 through S804 are repeated. Activated items of the trigger information are transmitted to the current state management server 10-2 in step S606 in FIG. 9.

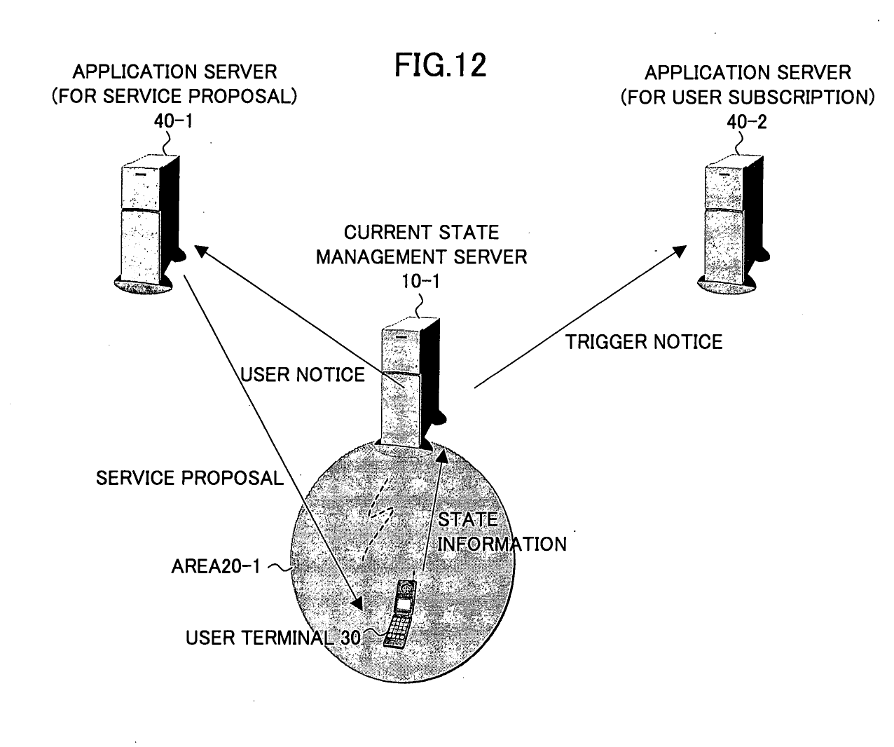

FIG. 12 is a schematic diagram showing the operation of the service providing system in which user state is updated. An application server 40-1 executes an application program for providing services, and another application server 40-2 executes an application program for registering service subscriptions. The current state management server 10 shown in FIG. 12 updates the user state corresponding to the user terminal 30 in response to receipt of the user state notice transmitted from the user terminal 30 in the area 20-1.

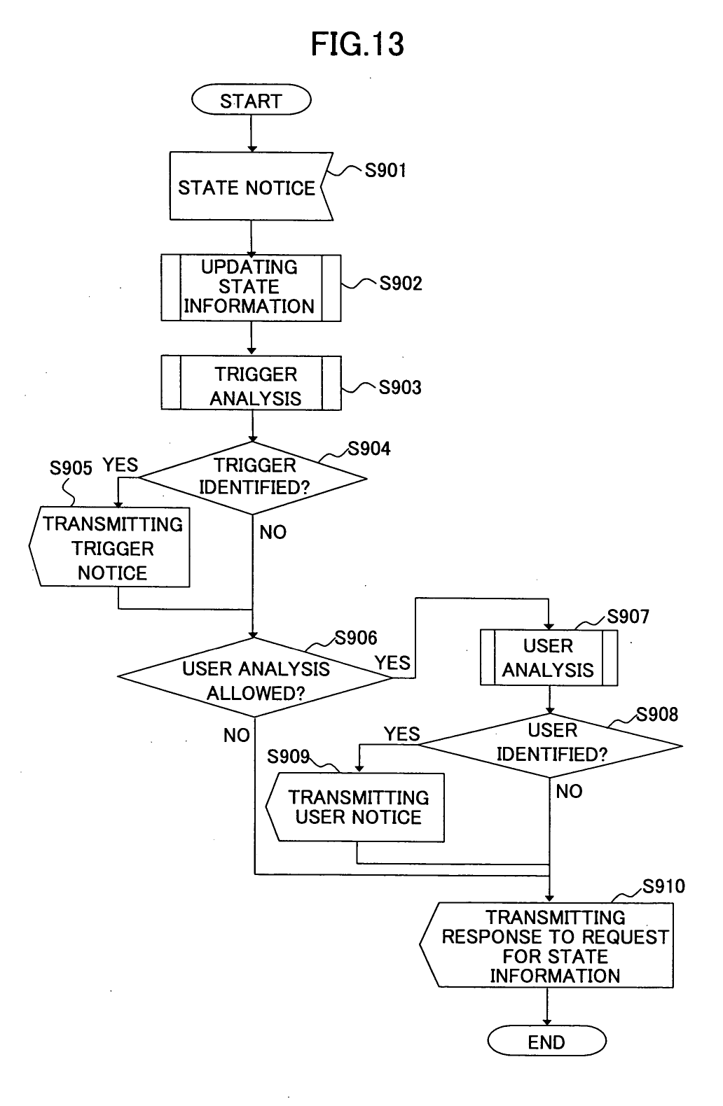

FIG. 13 is a flowchart showing the operation of the current state management server 10-1 shown in FIG. 12. The current state management server 10-1 receives a user state notice transmitted from the user terminal 30 (step S901). The state notice includes information related to the state of a user corresponding to the user terminal 30. The current state management server 10-1 updates the user state information corresponding to the user terminal 30 that the current state management server 10-1 manages (step S902). The current state management server 10-1 analyses the trigger information with reference to the updated user state information (step S903), and determines whether any item of the trigger information is identified by determining whether the state of the user satisfies a certain condition corresponding to the trigger information (step S904). If the trigger information is identified, the current state management server 10-1 transmits a trigger notice indicating the identified trigger to the application server 40 (application server 40-2 in this case) (step S905). The information includes identification information of the user corresponding to the user terminal 30. If no item of the trigger information is identified, step S905 is skipped.

The current state management server 10-1 determines whether user analysis is allowed (step S906). If the user analysis is allowed, the current state management server 10-1 analyses the user state of the user (step S907). The current state management server 10-1 further determines whether the condition of user notice is satisfied based on the analysis (step S908). If the condition of user notice is satisfied, the current state management server 10-1 transmits the user notice including the identification information of the user corresponding to the user terminal 30 to the application server 40 (the application server 40-1 in this case) (step S909). If the condition of user notice is not satisfied, step S909 is skipped.

If a determination is made in step S906 that the user analysis is not allowed, if a determination is made in step S908 that the condition of user notice is not satisfied, or if the identification information of the user is noticed in step S909, the current state management server 10-1 transmits the response to request for state information (step S910). According to another embodiment, step S910 may not be performed.

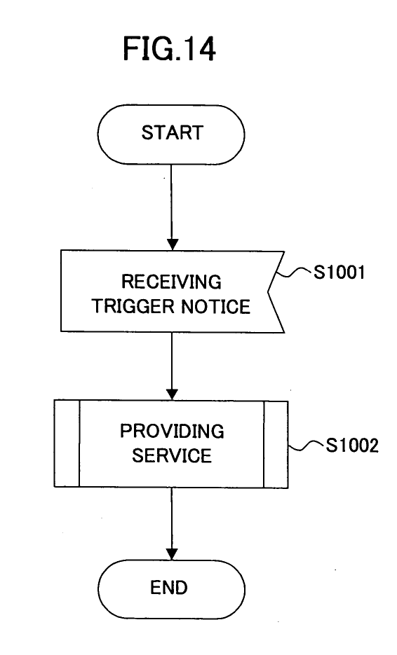

FIG. 14 is a flowchart showing the operation of the application server 40-2 that has received the trigger notice as shown in FIG. 12. In response to receipt of the trigger notice (step S1001), the application server 40-2 executes an application program for providing a service corresponding to the received trigger notice (step S1002). Processing of the application server 40-2 depends on the service provided to the user.

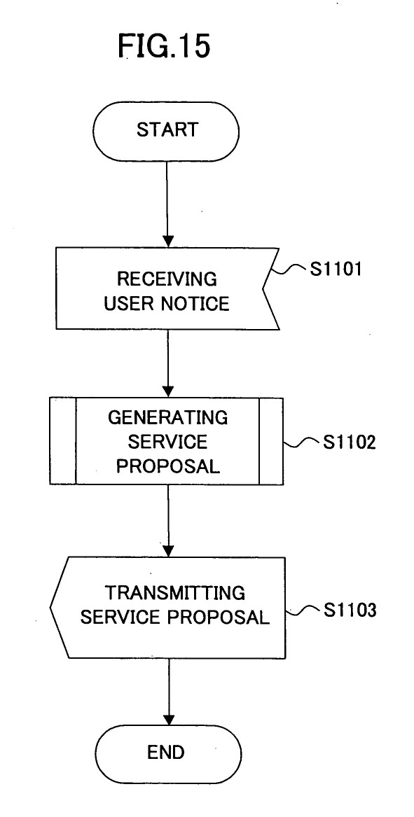

FIG. 15 is a flowchart showing the operation of the application server 40-1 that receives the user notice as shown in FIG. 12. In response to receipt of the user notice from the current state management server 10-1 (step S1101), the application server 40-1 generates a service proposal for the user identified by the information of the user (step S1102). The application server 40-1 transmits the generated service proposal to the user terminal 30 identified by the user notice (step S1103).

In response to receipt of the service proposal, the user terminal 30 requests a service among services included in the service proposal. The application server 40-1 executes the application program of the service requested by the user terminal 30. After providing the service requested by the user terminal 30, the application server 40-1 may charge a service charge to the account of the user corresponding to the user terminal 30.

The user terminal 30 may refuse receipt of the service proposal transmitted from the application server 40-1. In this case, the user terminal 30 may transmits a request for not transmitting the service proposal. In response to receipt of the request for not transmitting the service proposal, the application server 40-1 stops transmitting the service proposal to the user terminal 30.

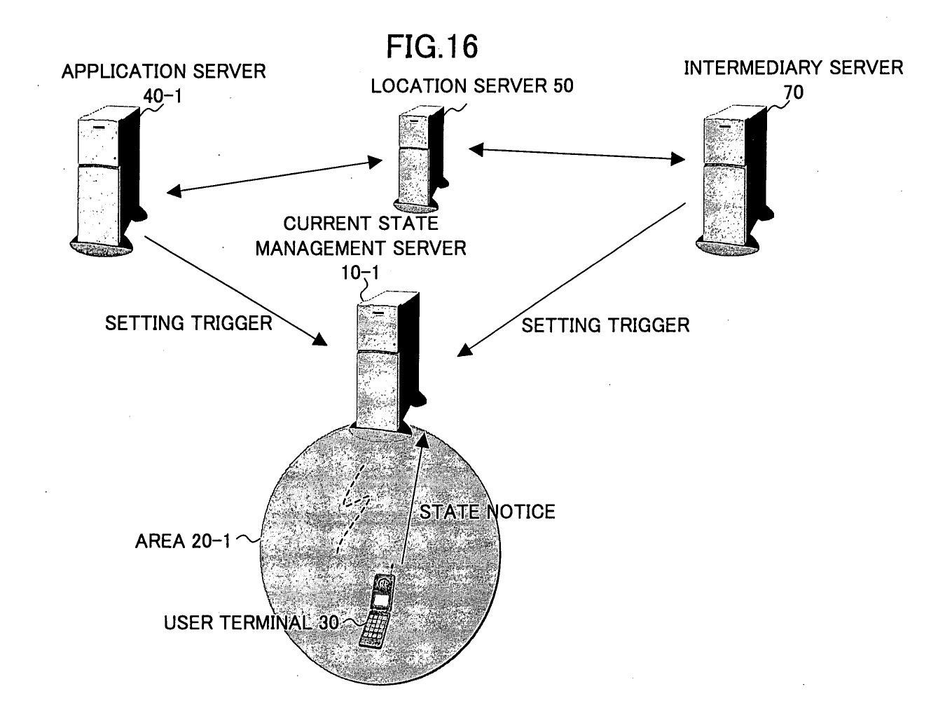

FIG. 16 is a schematic diagram showing the operation of the service providing system in which a new trigger is set. The application server 40-1 transmits a request for setting a trigger, directly or via the intermediary server 70, to the current state management server 10-1 of the area 20-1 in which the user terminal 30 stays. In response to receipt of the request, the current state management server 10-1 sets a new item of trigger information corresponding to the user terminal 30. Additionally, if the state of the user corresponding to the user terminal 30 satisfies a certain condition corresponding to the new item of trigger information, the current state management server 10-1 transmits a trigger notice to the application server 40-1. In response to receipt of the trigger-notice, the application server 40-1 executes an application program for providing a service to the user terminal 30. The intermediary server 70 shown in FIG. 16 is different from the intermediary server 70 shown in FIG. 2 in that it does not manage the position of the user terminal 30.

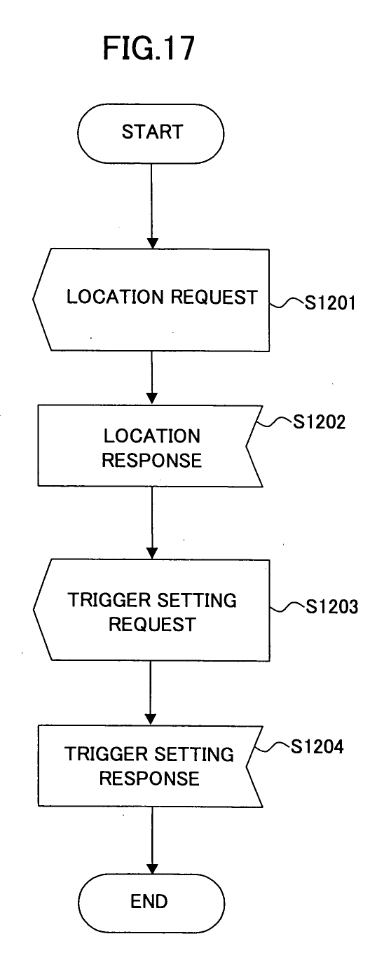

FIG. 17 is a flowchart showing the operation of the application server 40-1 shown in FIG. 16. The application server 40-1 transmits a location request to the location server 50 (step S1201), the location request being an inquiry for the address of the current state management server 10-1 responsible for the area 20-1 in which the user terminal 30 stays. The application server 40-1 receives a location response from the location server 50 (step S1202), the location response including the address of the current state management server 10-1. The application server 40-1 transmits a trigger setting request to the current state management server 10-1 (step S1203), the trigger setting request being a request for setting an item of trigger information corresponding to the user terminal 30 activated for analysis. The application server 40-1 receives a trigger setting response from the current state management server 10-1 (step S1204), the trigger setting response being a response that the trigger information is set activated for analysis.

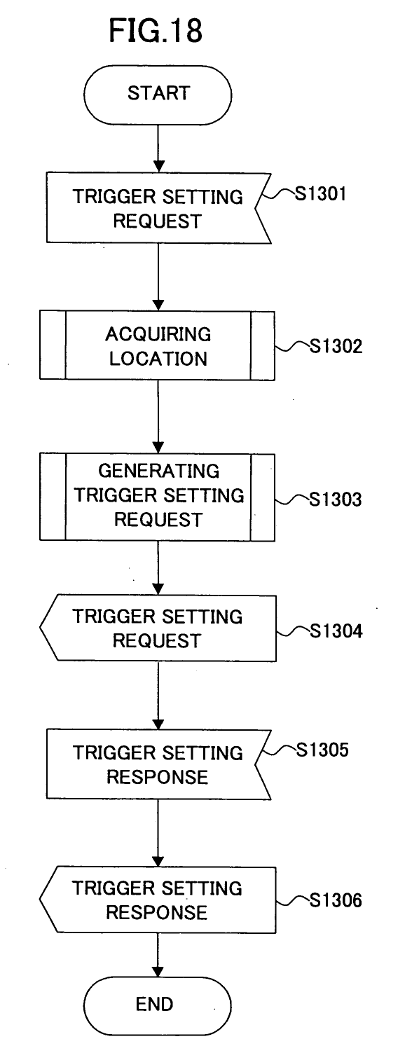

FIG. 18 is a flowchart showing the, operation of the location server 50 shown in FIG. 16. The location server 50 receives a trigger setting request from the application server 40-1 (step S1301). The location server 50 acquires the address of the current state management server 10-1 responsible for the area 20-1 in which the user terminal 30 under the control of the location server 50 stays (step S1302).

The location server 50 generates a trigger setting request (step S1303), and transmits the generated trigger setting request to the current state management server 10-1 of the acquired address (step S1304). The application server 40-1 receives a trigger setting response from the current state management server 10-1 (step S1305), and transmits the received trigger setting response to the application server 40-1 (step S1306).

According to the present embodiment described with reference to FIGS. 17 and 18, the location server 50 retains the address of the current state management server 10-1 responsible for the area 20-1 in which the user terminal 30 stays. According to another embodiment, another server may retain the address of the current state management server 10-1.

The operation of the service providing system according to the present embodiment is further described with reference to sequence charts.

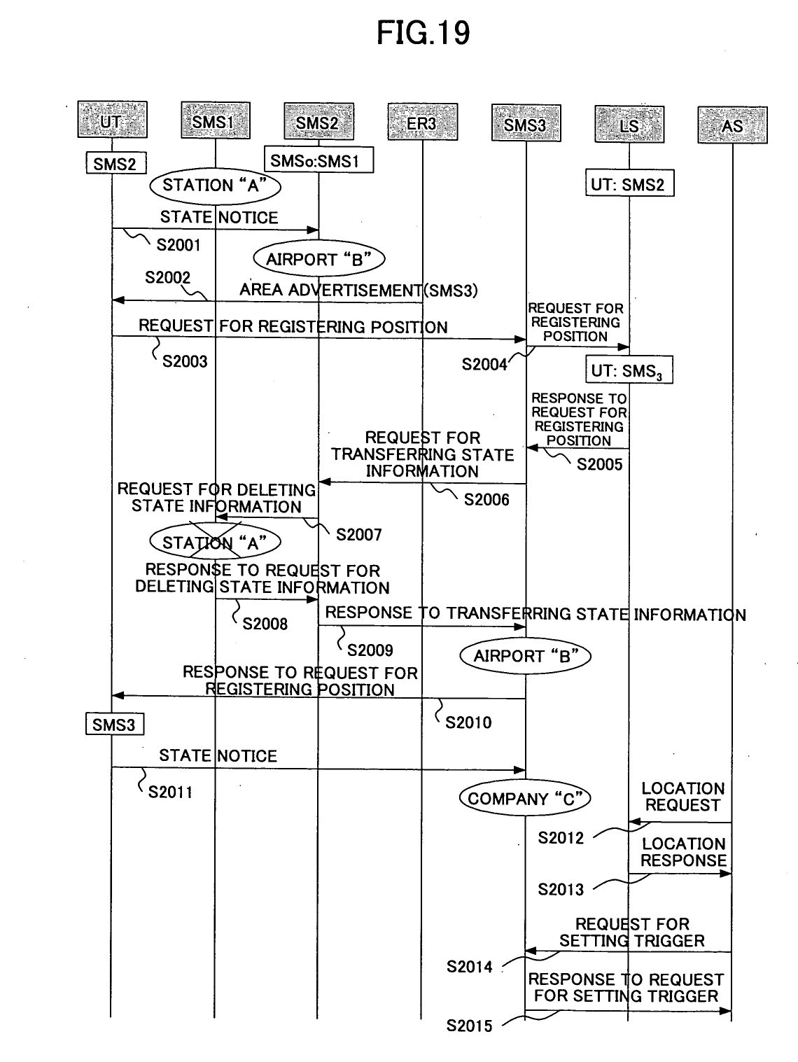

FIG. 19 is a sequence chart showing a first embodiment of user state management. The user state information corresponding to the user terminal (UT) is managed by only one of the state management servers (SMS) 1, 2, or 3.

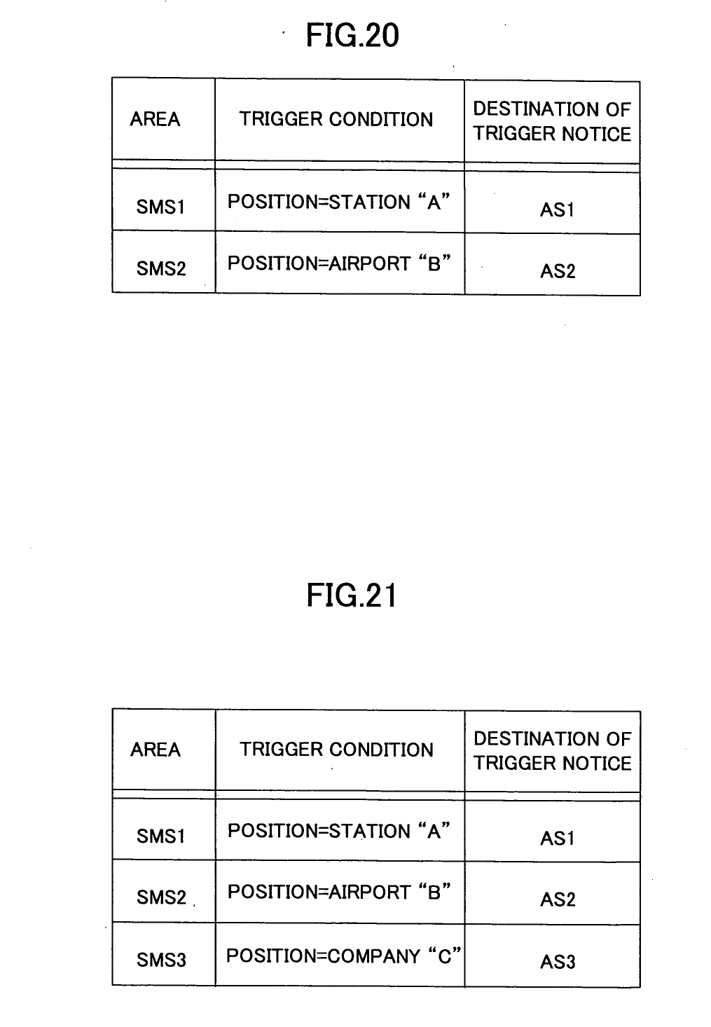

The UT stays in an area, a station “A”, for which the SMS 1 is responsible, and moves to an area, an airport “B”, for which the SMS 2 is responsible. Accordingly, the user state information corresponding to the UT is managed by the SMS 1, and then, is managed by the SMS 2. The trigger information corresponding to the UT is managed together with the user state information by the SMS 1, and then, is managed by the SMS 2. FIG. 20 shows exemplary trigger information managed by the SMS 2. Two items of trigger information are shown in FIG. 20. The first item of the trigger information indicates that, when the UT stays in the area, the station “A”, for which the SMS 1 is responsible, the SMS 1 transmits a trigger notice to an application server 1 (AS 1) so that the AS 1 can execute an application program. The second item of the trigger information indicates that, when the UT stays in the area, the airport “B”, for which the SMS 2 is responsible, the SMS 2 transmits a trigger notice to an application server 2 (AS 2) so that the AS 2 can execute an application program.

When staying in the area, airport “B”, for which the SMS 2 is responsible, the UT transmits a state notice to the SMS 2 (step S2001). When moving to an area, a company “C”, for which the SMS 3 is responsible, the UT receives an area advertisement from a router 3 (ER 3) corresponding to the company “C” (step S2002).

In response to receipt of the area advertisement, the UT recognizes that it has moved from the area (airport “B”) for which the SMS 2 is responsible to the area (company “C”) for which the SMS 3 is responsible. The UT transmits a request for registering position to the SMS 3 (step S2003). According to the present embodiment, the address of the SMS 3 may be included in the area advertisement from the ER 3, or may be retained by the UT in advance. According to another embodiment, the UT may acquire the address of the SMS 3 in accordance with a procedure such as Universal Plug and Play (UPnP). The request for registering position may be transferred to the SMS3 via the ER 3. If a user terminal has GPS function, positional information acquired by the GPS function such as latitude, longitude, and altitude of the user terminal may be provided to the SMS3. In such a case, a trigger condition may be defined by latitude, longitude, and altitude of an area (station A, for example).

In response-to receipt of the request for registering position, the SMS 3 transmits the request for registering position to the location server (LS) (step S2004). In response to receipt of the request for registering position from the SMS 3, the LS updates the position information of the UT from “SMS 2” to “SMS 3”. The LS transmits a response to the request for registering position to the SMS 3 (step S2005). Since the UT has moved from the area airport B for which the SMS 2 is responsible to the area company “C”, the LS includes the address of the SMS 2 in the response.

In response to receipt of the response to the request for registering position, the SMS 3 transmits a request for transferring state information to the SMS 2 that is identified by the address included in the response (step S2006). According to another embodiment, if the UT includes the address of the SMS 2 in the request for registering position, the SMS 3 may identify the SMS 2 in accordance with the address included in the request.

The UT has moved to the area airport “B” from the area station “A” for which the SMS 1 is responsible. In response to receipt of the request for transferring the state information, the SMS 2 transmits a request for deleting state information to the SMS 1 (step S2007). In response to receipt of the request for deleting state information, the SMS 1 deletes the user state information corresponding to the UT. The SMS 1 transmits a response to the request to the SMS 2 (step S2008).

The SMS 2 transmits a response to the request for transferring state information to the SMS 3 (step S2009). The SMS 2 includes the user state information and the trigger information corresponding to the UT in the response.

The SMS 3 manages the user state information and the trigger information corresponding to the UT included in the response to the request for transferring state information. The SMS 3 sets only items of the trigger information that are effective in the SMS 3 area, activated for analysis. The SMS 3 stores the other items without activating for analysis. For example, the trigger information shown in FIG. 20 includes no trigger information effective in the SMS 3 area (the area for which the SMS 3 is responsible). Accordingly, if the SMS 3 receives the response to the request for transferring state information from the SMS 2 including only the trigger information shown in FIG. 20, the SMS 3 stores items of the trigger information without activating them (step S2010). In response to receipt of the response, the UT transmits the state notice to the SMS 3 (step S2011).

If the UT starts subscribing to a new service, and a new item of trigger information is needed, an application server (AS) that executes the application program for the new service transmits a location request to the LS (step S2012). In response to receipt of the location request, the LS transmits the address of the SMS 3 to the AS as the position information of the UT (step S2013). In response to receipt of the location response, the AS transmits a request for setting trigger to the SMS 3 that is identified by the address included in the location response (step S2014). In response to receipt of the request for setting trigger, the SMS 3 sets a new item of trigger information corresponding to the UT. As shown in FIG. 21, the trigger information corresponding to the UT managed by the SMS 3 includes both the trigger information received from the SMS 2 and the trigger information set by the SMS 3 in response to receipt of the request for setting trigger. The SMS 3 activates only items of the trigger information effective in the SMS 3 area for analysis, and stores the other items of the trigger information without setting them activated for analysis. After setting the new item of the trigger information, the SMS 3 transmits a response to the request for setting trigger to the AS (step S2015).

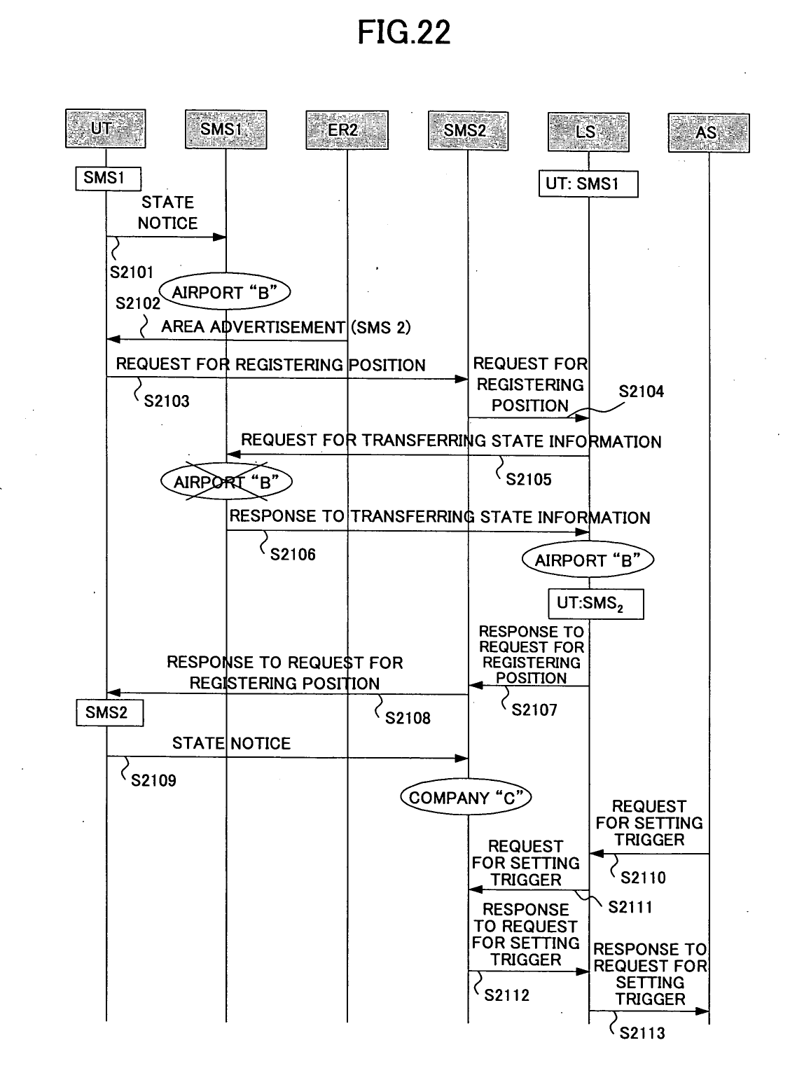

FIG. 22 is a sequence chart showing a second embodiment of user state management. When the UT stays in the SMS 1 area, airport “B”, the UT transmits the state information to the SMS 1 (step S2101). When the UT moves to the SMS 2 area (the area for which the SMS 2 is responsible), that is, company “C”, the UT receives an area advertisement from a router 2 (ER 2) corresponding to the company “C” (step S2102).

When the UT receives the area advertisement, the UT recognizes that the UT has moved from the SMS 1 area (airport “B”) to the SMS 2 area (company “C”), and transmits a request for registering position to the SMS 2 (step S2103).

In response to receipt of the request for registering position, the SMS 2 transmits the received request for registering position to the location server (LS) (step S2104). In response to receipt of the request for registering position, the LS recognizes that the UT has moved from the SMS 1 area to the. SMS 2 area, and updates the position information of the UT. Additionally, the LS transmits a request for transferring the state information to the SMS 1 that is responsible for the airport B (step S2105).

In response to receipt of the request for transferring the position information, the SMS 1 deletes the position corresponding to the UT, but transmits a response to the request for transferring the state information including the user state information and the trigger information of the UT (step S2106).

The LS manages the user state information and the trigger information of the UT included in the response. Additionally, the LS updates the position information of the UT from the SMS 1 area to the SMS 2 area, and transmits a response to the request for registering position to the SMS 2 (step S2107). The response to the request for registering position includes the user state information and the trigger information of the UT.

The SMS 2 manages the user state information and the trigger information of the UT included in the response. The SMS 2 activates for analysis only items of the trigger information that are effective in the SMS 2 area (the area for which the SMS 2 is responsible). The SMS 2 stores the other items of the trigger information without activating them for analysis. The SMS 2 transmits a response to the request for registering position to the UT (step S2108). In response to receipt of the response, the UT transmits the state information to the SMS 2 (step S2109).

If the UT starts subscribing to a new service, and new trigger information is needed, an application server (AS) that executes the application program for providing the new service transmits a trigger setting request to the LS (step S2110). In response to receipt of the trigger setting request, the LS transmits the received trigger setting request to the SMS 2 that is responsible for the area in which the UT stays (step S2111).

In response to receipt of the trigger setting request, the SMS 2 creates a new item of the trigger information corresponding to the UT. The SMS 2 manages both the items of the trigger information received from the SMS 1 and the newly created item of the state information. The SMS 2 activates for analysis only the items of the trigger information effective in the SMS 2 area, and stores the other items of the trigger information without activating them for analysis. After creating the new item of the trigger information, the SMS 2 transmits a response to the trigger setting request to the AS (step S2112). In response to receipt of the response, the LS transmits the received response to the LS (step S2113).

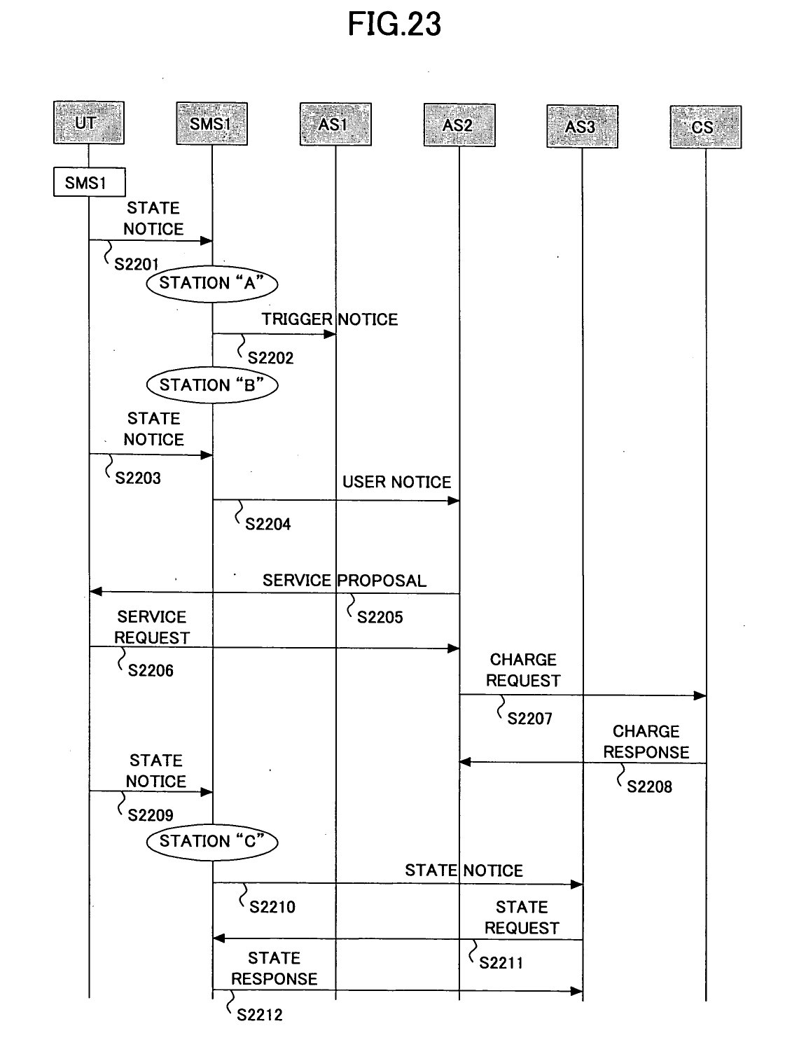

FIG. 23 is a sequence chart showing a third embodiment of the user state management. In this case, the state management server 1 (SMS 1) is responsible for the areas of the station “A”, the station “B”, and the station “C”.

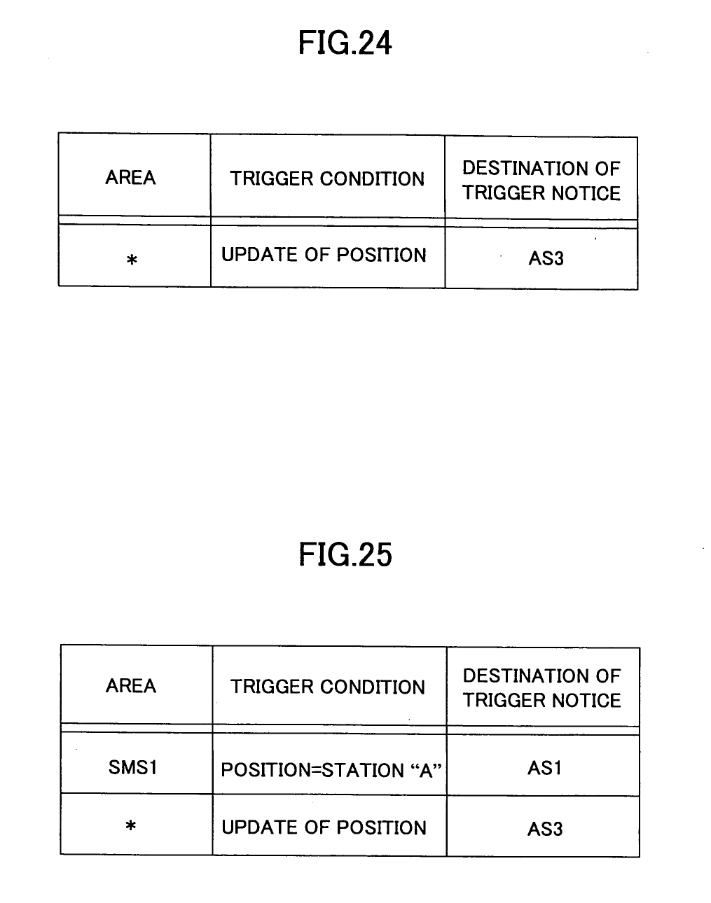

The application server,3 (AS 3) has requested the SMS 1 to create an item of the trigger information for state information. The SMS 1 has created the item of the trigger information for state information as shown in FIG. 24. A mark “*” indicates a so-called wild card meaning that, when the UT stays in any area for which any SMS is responsible, and the position of the UT is updated, a trigger notice is transmitted from the SMS to the AS 3.

As shown in FIG. 25, the trigger information managed by the SMS 1 may include an item of state information and other items. In the trigger information shown in FIG. 25, the first item indicates that, when the UT stayslin the.SMS 1 area, station “A”, the SMS 1 transmits the trigger notice to the AS 1 so that the AS 1 can execute an application program for providing service to the UT 1.

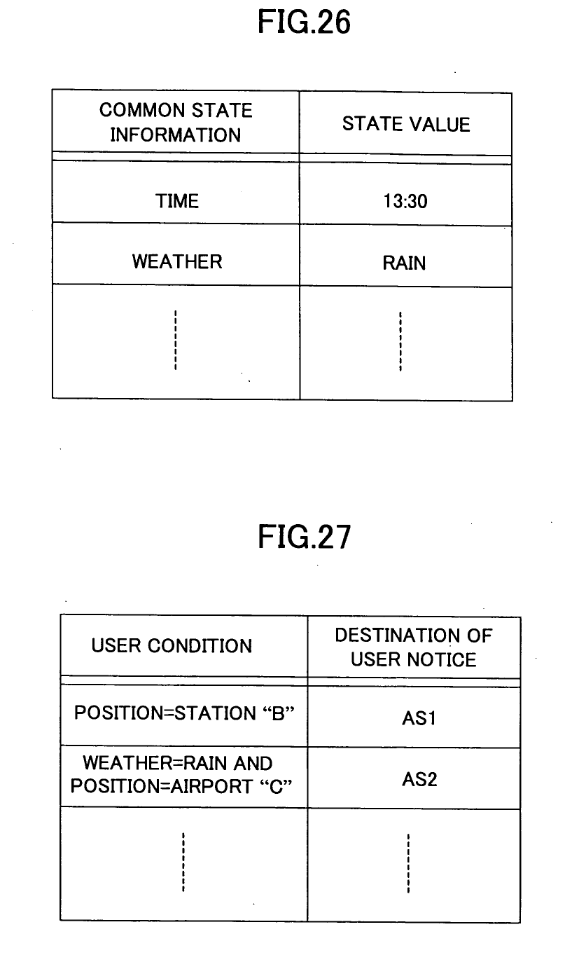

Additionally, the SMS 1 manages common state information as shown in FIG. 26. The common state information is common to all users who stay in the SMS 1 area. The common state information shown in FIG. 26 includes “time” and “weather”, for example. The common state information may be further detailed for each part of the SMS 1 area. For example, the common state information may include “the weather around the station “A”.

The SMS 1 may manage user analysis information as shown in FIG. 27. The SMS 1 uses the user analysis information for analyzing the user. In the user analysis information shown in FIG. 27, the first item indicates that, when the UT stays in the station “B”, the SMS 1 transmits user information to the AS 1 so that the AS 1 can execute an application program for providing the user with a service. The second item indicates that, when the weather is rain, and the UT stays in the airport “C”, the SMS 1 transmits user information to the AS 2 so that the AS 2 can execute an application program. For example, the second item -of the user analysis information is applicable in such a case that, when a user arrives at the airport “C” on a rainy day, a taxi is sent with high priority to pick up the user. It is also possible that, if the number of users who satisfy the user analysis information is more than a predetermined number, the SMS 1 transmits the user information to the AS 2.

Returning to FIG. 23, in response to the execution of the application program by the AS 2, a charge server (CS) charges the user of the UT.

The user terminal (UT) stays in the SMS 1 area, the station “A”, and transmits state information to the SMS 1 (step S2201). The SMS 1 performs trigger analysis based on the latest user state information corresponding to the UT. The SMS 1 may additionally perform user analysis. If the state of the user of the UT satisfies a predetermined user condition, the SMS 1 transmits the trigger notice (step S2202). In response to the trigger notice, the AS 1 executes the application program for providing the UT with a service.

When the UT moves from the station “A” to the station “B”, the UT transmits state information to the SMS 1 (step S2203). In response to receipt of the state information, the SMS 1 performs user analysis based on the latest user state information corresponding to the UT. The SMS 1 may performs the trigger analysis as well.

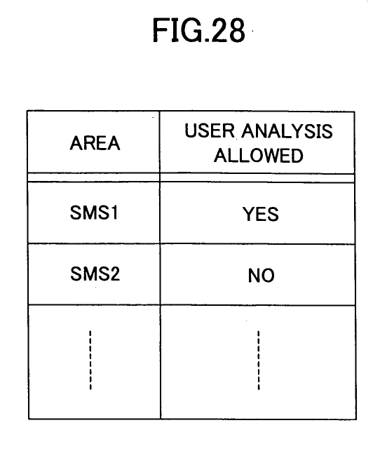

Specifically, the SMS 1 determines whether the user analysis is allowed in the SMS 1 area based on user analysis allowance information shown in FIG. 28 indicating whether the user analysis is allowed. The user analysis allowance information is transferred from one SMS to another SMS together with the user state information and the trigger information as the UT moves. The SMS 1 may use only an item of the user analysis allowance information that is relevant to the SMS 1 area for the determination. The user analysis allowance information may be generated by the user. According to another embodiment, the SMS 1 may query another server for the user analysis allowance information.

The user analysis allowance information shown in FIG. 28 indicates whether the user analysis is allowed in each area. According to another embodiment, the user analysis allowance information may indicate whether the user analysis is allowed for each service, or each application server that executes the application program for providing the service. According to yet another embodiment, the user analysis may be allowed for all areas, or may be prohibited for all areas.

If the user analysis is allowed in the SMS 1 area, the SMS 1 determines, based on the user state information, whether the user corresponding to the UT satisfies the user condition indicated in the user analysis information shown in FIG. 27. If the user satisfies the user condition, the SMS 1 transmits user information including the identification information of the user to the AS (AS 2 in this case) (step S2204).

The AS 2 makes proposals of services that the AS 2 can provide to the user identified by the received user information (step S2205). The proposals are transmitted to the UT identified by the identification information included in the user information, such as the mail address, the address for instant messaging, and the phone number of the UT. For example, if the AS 2 executes an application program for a Web service, the AS 2 transmits an instant message including the advertisement and the URL of the Web service to the UT.

When the user operates the UT and selects one or more of the proposed services, the UT transmits the selection to and requests the AS 2 for the selected service (step S2206). The AS 2 executes the application program corresponding to the requested service, and transmits a charge request to the CS (step S2207). In response to receipt of the charge request, the CS generates and stores a charge record corresponding to the user of the UT. The CS returns a response to the charge request to the AS 2 (step S2208).

When moving from the station “B” to the station “C”, the UT transmits a state notice to the SMS 1 (step S2209). The SMS performs the trigger analysis based on the received latest user state information corresponding to the UT. If the state of the user corresponding to the UT satisfies the trigger condition shown in FIG. 24, the SMS 1 transmits the trigger notice (state notice) indicating the satisfaction of the trigger condition to the AS 3 (step S2210). In response to receipt of the state notice, the AS 3 transmits a state request to the SMS 1 (step S2211), and the SMS 1 returns a state response including the user state information of the UT to the AS 3 (step S2212).

As described above, a state management server 10 is provided to each area 20 that constitutes a service area, and the state management server 10 manages the state information of a user (user terminal) who stays in the area 20. According to the above arrangements, the state management server 10 needs to manage only the state information of users who stay in the area 20 for which the state management server 10 is responsible. Even if there are a large number of users staying in a large service area, and many items of state information need to be managed for each user, each state management server 10 is prevented from being overloaded. Since the state management server 10 can be provided in or near the area 20, the distance between the state management server 10 and each user terminal 30 is reduced, which results in the reduction of network load.

When the user terminal 30 moves from one area 20 to another area 20, the user state information and the trigger information corresponding to the user terminal 30 are transmitted from the state management server 10 of the area 20 in which the user terminal 30 has previously been to the current state management server 10 of the area 20 in which the user terminal 30 is presently staying. As a result, as the user (user terminal) moves in the service area, the service providing system can keep providing services to the user (user terminal 30).

Additionally, the state management server 10 identifies items of the trigger information that are effective in the area 20 for which the state management server 10 is responsible and, if a predetermined user condition corresponding to the identified items of the trigger information is met, transmits a trigger notice to the application server 40 for causing the application server 40 to execute an application program. Accordingly, whereas the load of the state management server 10 is minimized, the service providing system can provide suitable services to the user in accordance with the state of the user.

The application server 40 can propose (offer) services to the user terminal 30, and give the user opportunities to make selections from various services.

The charge server charges a certain amount to the user terminal 30 for the services provided to the user terminal 30, which rhakes the service providing system suitable for business.

According to the embodiment described above, the position of a user terminal 30 is specified using the address of the state management server 10. According to another embodiment, the position of the user terminal 30 may be specified by the identification information of the area 20. In this case, the identification information of the area 20 is correlated to the address of the state management server 10.

The present invention is not limited to these embodiments, but various variations and modifications may be made without departing from the scope of the present invention.

This patent application is based on Japanese Priority Patent Application No. 2003-092864 filed on Mar. 28, 2003, the entire contents of which are hereby incorporated by reference.

What is claimed is:

1. A service providing system, comprising:
a plurality of state management servers each provided to a segment of a service area, wherein, when a user terminal stays in the segment to which said state management server is provided, said state management server manages state information of the owner of the user terminal; and
an application server that executes an application program for providing the user terminal with a service.

2. The service providing system as claimed in claim 1, wherein
when the user terminal moves from a first segment of the service area to a second segment of the service area, a first one of said state management servers provided to the first segment of the service area transmits the state information of the owner of the user terminal to a second one of said state management servers provided to the second segment of the service area.

3. The service providing system as claimed in claim 1, wherein
said state management servers are disposed in the neighborhood of the respective segments of the service area.

4. The service providing system as claimed in claim 1, wherein
said state management server transmits, to said application server, identification information of the owner of the user terminal staying in the segment of the service area to which said state management server is provided; and
said application server executes the application program for providing the service to the user terminal identified with the identification information of the owner of the user terminal.

5. The service providing system as claimed in claim 4, wherein
said state management server, if the state information of the owner of the user terminal staying in the segment of the service area to which said state management server is provided satisfies a predetermined user condition, transmits the identification information of the owner of the user terminal to said application server.

6. The service providing system as claimed in claim 5, wherein
when the user terminal moves from a first segment of the service area to a second segment of the service area, a first one of said state management servers provided to the first segment of the service area transmits the predetermined user condition corresponding to the user terminal to a second one of said state management servers provided to the second segment of the service area.

7. The service providing system as claimed in claim 5, wherein
said state management server identifies an item of the predetermined user condition that is effective in the segment of the service area to which said state management server is provided, and transmits, if the state information of the owner of the user terminal satisfies the identified item of the predetermined user condition, the identification information of the owner of the user terminal to said application server.

8. The service providing system as claimed in claim 1, wherein
said application server sends a service proposal to the user terminal identified with identification information transmitted from said state management server.

9. The service providing system as claimed in claim 8, wherein
the user terminal requests said application server for one or more services proposed in the service proposal.

10. The service providing system as claimed in claim 1, further comprising:
a charge server that charges for the service provided by said application server.

11. The service providing system as claimed in claim 5, wherein
said state management server determines, if and only if the determination is allowed, whether the user state information satisfies the predetermined user condition.

12. The service providing system as claimed in claim 8, wherein
the user terminal can refuse the sending of the service proposal by said application server.

13. The service providing system as claimed in claim 1, further comprising:
an intermediary server that intermediates communications among said state management servers, and manages the state information of the user.

14. The service providing system as claimed in claim 1, wherein
said state management server transmits, to said application server, the state information of the owner of the user terminal staying in the segment of the service area to which said state management server is provided.

15. The service providing system as claimed in claim 1, wherein
said state management server manages state information common to a plurality of owners of user terminals staying in the segment of the service area to which said state management server is provided.
